(19) United States
(12) Patent Application Publication
(10) Pub. No.: US 2022/0016667 A1
(43) Pub. Date: Jan. 20, 2022

(54) SUPPLY SYSTEM, METHOD FOR LOADING A FEED DEVICE WITH A COATING MATERIAL, AND USE OF A MANIPULATOR

(71) Applicant: HOMAG GmbH, Schopfloch (DE)

(72) Inventors: Reiner GÖTZ, Horb-Diessen (DE); Johannes SCHMID, Starzach (DE)

(21) Appl. No.: 17/311,291

(22) PCT Filed: Dec. 5, 2019
(86) PCT No.: PCT/EP2019/083807

§ 371 Date: Jun. 4, 2021

(51) Int. Cl. B05C 11/10; B25J 11/00

(52) U.S. Cl. CPC B05C 11/1044; B25J 11/0075

(57) ABSTRACT

The present invention discloses a supply system for supplying a coating material to a feed device for feeding a coating material to a machining device, wherein the supply system comprises: a storage device configured to store at least one coating material, and a manipulator configured to transfer coating material between the feed device and the storage device.

### SUBJECT MATTER OF THE INVENTION

The present invention relates to a supply system. Moreover, the present invention relates to a method for loading a feed device with a coating material, and to the use of a manipulator.

### PRIOR ART

It has proven effective to coat cut surfaces of plate-shaped workpieces, so-called workpiece narrow surfaces, with an approximately strip-shaped coating material. On the one hand, this allows the narrow surface to be adapted to the properties of the workpiece surface of the workpiece without requiring time-consuming finishing. On the other hand, such a coating allows the core of the workpiece to be made of a different, e.g. cheaper, material than the surfaces that are visible to the outside. This coating usually takes place on a machining device.

An adhesive or glue is used to bond the workpiece to the coating material. In particular, an adhesive is used here which is activated by an energy input and can only then produce a load-bearing bond between two components (coating material and workpiece).

Machining devices can usually be used with different workpieces, i.e. with workpieces of different sizes and/or materials. However, these different workpieces usually also require different coating materials.

Therefore, it is known to provide feed devices on machining devices, which can feed different coating materials to a machining device. Such a feed device is disclosed in DE 10 2009 021 676 A1.

However, for reasons of space and complexity, such feed devices can only accommodate a limited number of coating materials.

### DESCRIPTION OF THE INVENTION

Based on that explained above, the object of the present invention was to provide a solution that is able to supply a large number of coating materials to a machining device without violating the limitations regarding space and complexity.

As a solution, the present invention provides the supply system of claim 1.

The invention was based on the recognition that the aforementioned problems are mainly due to the fact that there is little space for the provision of coating materials on a machining device, and therefore the space available can only be better utilized by means of increasing complexity.

In view of these recognitions, the present invention provides a supply system for supplying a coating material to a feed device for feeding a coating material to a machining device, which has a storage device and a manipulator. The feed device serves to feed a coating material to a machining device, the feed device being configured to accommodate at least one coating material that can be fed to the machining device. The storage device is configured to store at least one coating material, and the manipulator is configured to transfer coating material between the feed device and the storage device.

This makes it possible to supply any number of coating materials to a machining device, without these having to be stored on the machining device.

The storage device is preferably configured to accommodate a plurality of coating materials and to supply these to the feed device as needed by means of the manipulator.

The manipulator is preferably an articulated arm robot and in particular a multi-axis robot and more preferably a 5-axis or 6-axis robot.

Alternatively, the manipulator may be a linear table and the storage device may be configured to enable a movement of a stored coating material in at least one axis.

Further alternatively, the manipulator is preferably an articulated arm robot and the storage device is configured to store coating materials in at least one plane such that coating materials in different storage positions of the storage device can be reached by the manipulator, wherein, optionally, the coating materials can be moved in the at least one plane of the storage device.

Furthermore, the manipulator may be a mobile robot, and in particular an autonomous mobile robot, which is configured to pick up coating materials at a storage device, transport them to a feed device, and unload them at the feed device and/or to pick up coating materials at a feed device, transport them to a storage device, and unload them at the storage device.

The present invention further provides a feed system, the feed system comprising: a supply system as described above, a feed device for feeding a coating material to a machining device, the feed device being configured to accommodate at least one coating material (1, 1b) which can be fed to the machining device.

Furthermore, the present invention provides a method for loading a feed device with a coating material, comprising the following steps: Selecting a coating material from a storage device and transferring the selected coating material between the storage device and the feed device.

It is preferred that the transfer is carried out by means of a manipulator.

It is further preferred that the method is carried out using a feed system as described above.

Furthermore, the present invention provides the use of a manipulator to transfer a coating material from a storage device to a feed device.

This is preferably done by means of the method as previously defined and/or by means of the supply system as previously defined.

The present invention further provides a machining apparatus comprising: a machining device for coating a workpiece with a coating material, and a feed system as previously defined.

### BRIEF DESCRIPTION OF THE DRAWINGS

FIG. 1 shows a preferred embodiment of a feed system according to the invention on a machining device.

### PREFERRED EMBODIMENTS OF THE PRESENT INVENTION

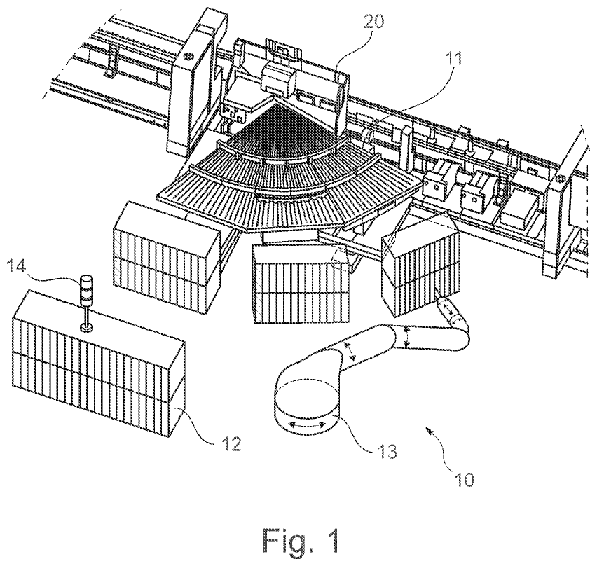

FIG. 1 shows a preferred first embodiment of a supply system according to the invention.

The supply system 10 is provided on a machining device 20. In the preferred embodiment shown, the machining device 20 is an edge bonding device in continuous operation, which is able to bond edges of workpieces with a coating material. This is done by means of an energy input into the coating material, e.g. by using hot air or a laser. After this energy input, the coating material is pressed against the workpiece and thus firmly bonded. Further and/or other machining steps are also possible on the machining device 20. Furthermore, the machining device 20 can be arranged upstream and/or downstream of further machining devices that carry out further machining steps on workpieces in order to thus obtain desired products from workpieces.

The supply system 10 is arranged at that position of the machining device 20 where the coating material is to be applied to workpieces. A feed device 11 is arranged on the machining device 20. The feed device 11 is able to accommodate a plurality of coating materials 1a and 1b. For instance, these are arranged in a rolled-up manner and can be unrolled as needed. In the feed device 11, there is space for a limited number of coating materials, e.g. 24 coating materials. Usually, different coating materials are provided here, which are subsequently used by the machining device 20.

The coating materials 1a, 1b of the feed device 11 can be exchanged or replaced by the manipulator 13. In particular, this can be performed if a control device (not shown) reports that a coating material other than the coating materials 1a, 1b arranged in the feed device 11 is required. In this case, the manipulator 13 manipulates the required coating material in that its position is changed from a storage device 12 to the feed device 12.

In the present embodiment, the manipulator 13 is configured as a 6-axis robot, as shown in FIG. 1. The 6-axis robot has at its tip a gripping arm (not shown) that is configured to grip a new coating material and to subsequently change its position. Following a manipulation process, the gripping arm can release the coating material again and move to a neutral position. Alternatively, the manipulator 13 may also be a 5-axis robot or, in general, a multi-axis robot.

Possible directions of movement of the manipulator 13 are indicated by arrows in FIG. 1.

Thus, the feed device can be loaded with different coating materials as needed.

In the present embodiment, the storage device 12 is configured as a shelf system. A coating material may be provided in each compartment, either as a replacement for coating materials used up by the machining device or as coating materials of a different nature than the coating materials arranged in the feed device.

Furthermore, the storage device 12 may have a reporting device 14 that is configured to be able to report that an operator's attention is required here. For instance, this is the case if coating material is used up and/or if there are technical malfunctions. Reporting can be done by means of an optical and/or acoustic warning.

Together the storage device 12 and the manipulator 13 form a supply system 10 on the feed device 11.

Furthermore, the manipulator 13 is able to manipulate a coating material that has been moved to the feed device 11 in such a way that it can subsequently be used by the machining device 20. In particular, this manipulation means performing a threading operation such that this no longer has to be done manually.

In a second embodiment, which is not shown, the manipulator is configured as a linear table. This linear table enables a linear movement of a carriage on which a coating material to be moved may be arranged. In order to prevent that only one location in the storage device can be approached in this manner, the storage device in this second embodiment is configured to move individual storage locations such that different storage locations may be arranged relative to the linear table, in other words, are arranged such that an edge material arranged therein can be moved by the linear table.

A third embodiment, which is not shown, is substantially like the second embodiment described above, but has a cross table as the manipulator. The cross table is able to move in two planes and not in only one plane like a linear table. It is thus possible to enable the storage device to not have to have its own ability to move to reach different coating materials.

In a fourth embodiment, which is not shown, the manipulator is a mobile robot that can be controlled autonomously. Such an embodiment is particularly advantageous if there is a greater spatial distance between the storage device and the feed device 11. The autonomous robot may, for example, be controlled in or receive commands from a control center, based on which the robot moves coating materials between the storage device 12 and the feed device 11.

### REFERENCE NUMBERS

1a, 1b Coating material
10 Supply system
11 Feed device
12 Storage device
13 Manipulator
14 Reporting device
20 Machining device

1. Supply system for supplying a coating material to a feed device for feeding a coating material to a machining device, the supply system comprising:
a storage device configured to store at least one coating material, and
a manipulator configured to transfer coating material between the feed device and the storage device.

2. Supply system according to claim 1, wherein
the storage device is configured to accommodate a plurality of coating materials and to supply these to the feed device as needed by means of the manipulator.

3. Supply system according to claim 1, wherein
the manipulator is an articulated arm robot and preferably a multi-axis robot and more preferably a 5-axis or 6-axis robot.

4. Supply system according to claim 1, wherein
the manipulator is a linear table and the storage device is configured to enable a movement of a stored coating material in at least one axis.

5. Supply system according to claim 1, wherein
the manipulator is an articulated arm robot and
the storage device is configured to store coating materials in at least one plane
such that
coating materials in different storage positions of the storage device can be reached by the manipulator,
wherein, optionally, the coating materials can be moved in the at least one plane of the storage device.

6. Supply system according to claim 1, wherein
the manipulator is a mobile robot configured
to pick up coating materials at a storage device, transport them to a feed device, and unload them at the feed device
and
to pick up coating materials at a feed device, transport them to a storage device, and unload them at the storage device.

7. Supply system according to claim 1, wherein
the manipulator is configured to perform a threading operation on a coating material when it has been moved to a feed device.

8. Feed system comprising:
a supply system according to claim 1, and
a feed device for feeding a coating material to a machining device, wherein the feed device is configured to accommodate at least one coating material which can be fed to the machining device.

9. Method for loading a feed device with a coating material, comprising the following steps:
selecting the coating material from a storage device, and
transferring the selected coating material between the storage device and the feed device.

10. Method according to claim 9, wherein
the transfer is carried out by means of a manipulator.

11. Method according to claim 9, wherein
the method is carried out using a supply system according to claim 1.

12. (canceled)

13. Machining apparatus comprising:
a machining device for coating a workpiece with a coating material, and
a feed system according to claim 8.
